(19) United States
(12) Patent Application Publication
(10) Pub. No.: US 2012/0162358 A1
(43) Pub. Date: Jun. 28, 2012

(54) MOBILE TERMINAL CAPABLE OF PROVIDING MULTIPLAYER GAME AND OPERATION CONTROL METHOD THEREOF

(76) Inventor: Kyungdong CHOI, Seoul (KR)

(21) Appl. No.: 13/330,290

(22) Filed: Dec. 19, 2011

(30) Foreign Application Priority Data
Dec. 23, 2010 (KR) 10-2010-0133749

(51) Int. Cl. G06F 3/041; H04N 5/225

(52) U.S. Cl. 348/36; 345/173; 348/E05.024

(57) ABSTRACT

A method of controlling a mobile terminal and which includes allowing, via a wireless communication unit of the mobile terminal, wireless communication with at least one other terminal; displaying, on a touch screen display unit of the mobile terminal, a display screen; receiving, via a controller of the mobile terminal, a tap input performed on a main body of the mobile terminal; and dividing, via the controller controlling the touch screen display unit, the display screen into first and second display sections based on the received tap input.

### CROSS-REFERENCE TO A RELATED APPLICATION

This application claims the priority benefit of Korean Patent Application No. 10-2010-0133749, filed in Korea on Dec. 23, 2010, the disclosure of which is incorporated herein by reference.

### BACKGROUND OF THE INVENTION

1. Field of the Invention

The present invention relates to a mobile terminal and an operation control method of the mobile terminal, and more particularly, to a mobile terminal and an operation control method of the mobile terminal, in which various operations performed by the mobile terminal can be effectively controlled in response to a tap input being detected.

2. Description of the Related Art

Mobile terminals are portable devices, which can provide users with various services such as a voice calling service, a video calling service, an information input/output service, and a data storage service.

As the types of services provided by mobile terminals diversify, an increasing number of mobile terminals have been equipped with various complicated functions such as capturing photos or moving pictures, playing music files or moving image files, providing game programs, receiving broadcast programs and providing wireless internet services and have thus evolved into multimedia players.

Various attempts have been made to realize such complicated functions as hardware devices or software programs. For example, various user interface (UI) environments, in which users are allowed to easily search for and choose desired functions, have been developed.

However, there is a restriction in allocating sufficient space for the installation of UIs such as a display or a keypad without compromising the mobility and the portability of mobile terminals. Therefore, it is necessary to develop ways to control the operation of mobile terminals using a novel data input method and thus allowing the user to use various complicated functions of mobile terminals with convenience.

### SUMMARY OF THE INVENTION

The present invention provides a mobile terminal and an operation control method of the mobile terminal, in which various operations performed by the mobile terminal can be effectively controlled using a tap input and a touch input.

In one general aspect, an operation control method of a mobile terminal is provided, the operation control method including displaying a list screen including a list of a plurality of items on a display module that is provided in a main body of the mobile terminal; in response to a touch input being detected from the list screen, selecting at least one of the plurality of items; and in response to a tap input being detected from a particular part of the main body, performing a predefined operation corresponding to the selected item.

In another general aspect, a mobile terminal is provided including a display module configured to be provided in a main body of the mobile terminal and display a list screen including a list of a plurality of items; and a controller configured to select at least one of the plurality of items in response to a touch input being detected from the list screen, and perform a predefined operation corresponding to the selected item in response to a tap input being detected from a part of the main body.

In another general aspect, an operation control method of a mobile terminal is provided, the operation control method including displaying a list screen including a first list of a plurality of items on a display module that is provided in a main body of the mobile terminal; in response to a touch input being detected from the list screen, selecting at least one of the plurality of items; and in response to a tap input being detected from a particular part of the main body, dividing the list screen into first and second sub-screens, displaying the first list on the first sub-screen, and displaying a second list of one or more items relevant to the selected item on the second sub-screen.

In another general aspect, a mobile terminal is provided including a display module configured to be provided in a main body of the mobile terminal and display a list screen including a first list of a plurality of items; and a controller configured to select at least one of the plurality of items in response to a touch input being detected from the list screen, and to, in response to a tap input being detected from a particular part of the main body, divide the list screen into first and second sub-screens, display the first list on the first sub-screen, and display a second list of one or more items relevant to the selected item on the second sub-screen.

In another general aspect, an operation control method of a mobile terminal is provided, the operation control method including displaying an idle screen on a display module that is provided in a main body of the mobile terminal; in response to a first tap input being detected from a particular part of the main body, displaying a first menu screen on the display module; and in response to a second tap input that satisfies a predefined condition being detected from the particular part of the main body, displaying a second menu screen on the display module.

In another general aspect, a mobile terminal is provided including a display module configured to be provided in a main body of the mobile terminal and display an idle screen; and a controller configured to display a first menu screen on the display module in response to a first tap input being detected from a particular part of the main body, and display a second menu screen on the display module in response to a second tap input that satisfies a predefined condition being detected from the particular part of the main body.

In another general aspect, an operation control method of a mobile terminal is provided, the operation control method including displaying a preview screen on a display module that is provided in a main body of the mobile terminal; in response to a touch input being detected from the preview screen, capturing an image using the camera; and in response to a tap input being detected from a first part of the main body, displaying a panorama guide for capturing a panorama image along a direction corresponding to a position of the detection of the tap input.

In another general aspect, a mobile terminal is provided including a main body; a camera configured to be provided in the main body; a display module configured to display a preview screen provided by the camera; and a controller configured to capture an image using the camera in response to a touch input being detected from the preview screen, and display a panorama guide for capturing a panorama image along a direction corresponding to a position of the detection of the tap input in response to a tap input being detected from a first part of the main body.

In another general aspect, an operation control method of a mobile terminal is provided, the operation control method including displaying a document editor screen for editing an electronic document on a display module that is provided in a main body; and in response to a tap input being detected from a first part of the main body, dividing a display area on the display module into first and second sections, displaying the document editor screen on the first section, and displaying a list of a plurality of file items on the second section.

In another general aspect, a mobile terminal is provided including a display module configured to be provided in a main body and display a document editor screen for editing an electronic document; and a controller configured to, in response to a tap input being detected from a first part of the main body, divide a display area on the display module into first and second sections, display the document editor screen on the first section, and display a list of a plurality of file items on the second section.

In another general aspect, an operation control method of a mobile terminal is provided, the operation control method including displaying an operation screen corresponding to a multimedia file being played in a background on a display module that is provided in a main body of the mobile terminal; and in response to a first tap input being detected from the operation screen and being followed by a second tap input detected from a particular part of the main body, performing a predefined multimedia play control operation corresponding to a position of the detection of the second tap input.

In another general aspect, a mobile terminal is provided including a display module configured to be provided in a main body of the mobile terminal and display an operation screen corresponding to a multimedia file being played in a background; and a controller configured to, in response to a first tap input being detected from the operation screen and being followed by a second tap input detected from a particular part of the main body, performing a predefined multimedia play control operation corresponding to a position of the detection of the second tap input.

In another general aspect, a computer-readable recording medium is provided having recorded thereon a program for executing any one of the above-mentioned methods in a processor.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of a mobile terminal according to an embodiment of the present invention;

FIG. 2 illustrates a front perspective view of the mobile terminal shown in FIG. 1;

FIG. 3 illustrates a rear perspective view of the mobile terminal shown in FIG. 2;

FIGS. 4 and 5 illustrate diagrams for explaining the terms used in the description of the present invention;

FIG. 6 illustrates a flowchart of an operation control method of a mobile terminal, according to an embodiment of the present invention;

FIGS. 7A through 7C illustrate flowcharts of an operation control method of a mobile terminal, according to another embodiment of the present invention;

FIGS. 8 through 10 illustrate diagrams of various display screens for explaining the embodiments of FIGS. 6 and 7A through 7C;

FIG. 11 illustrates a flowchart of an operation control method of a mobile terminal, according to another embodiment of the present invention;

FIG. 12 illustrates diagrams of various display screens for explaining the embodiment of FIG. 11;

FIG. 13 illustrates a flowchart of an operation control method of a mobile terminal, according to another embodiment of the present invention;

FIG. 14 illustrates diagrams of various display screens for explaining the embodiment of FIG. 13;

FIG. 15 illustrates a flowchart of an operation control method of a mobile terminal, according to another embodiment of the present invention;

FIG. 16 illustrates diagrams of various display screens for explaining the embodiment of FIG. 15;

FIG. 17 illustrates a flowchart of an operation control method of a mobile terminal, according to another embodiment of the present invention; and

FIGS. 18 and 19 illustrate diagrams of various display screens for explaining the embodiment of FIG. 17.

### DETAILED DESCRIPTION OF THE INVENTION

The present invention will hereinafter be described in detail with reference to the accompanying drawings in which embodiments of the invention are shown.

The term ‘mobile terminal’, as used herein, indicates, but is not limited to, a mobile phone, a smart phone, a laptop computer, a digital broadcast receiver, a personal digital assistant (PDA), a portable multimedia player (PMP), a camera, a navigation device, a tablet computer or an electronic-book (e-book) reader. In this disclosure, the terms ‘module’ and ‘unit’ can be used interchangeably.

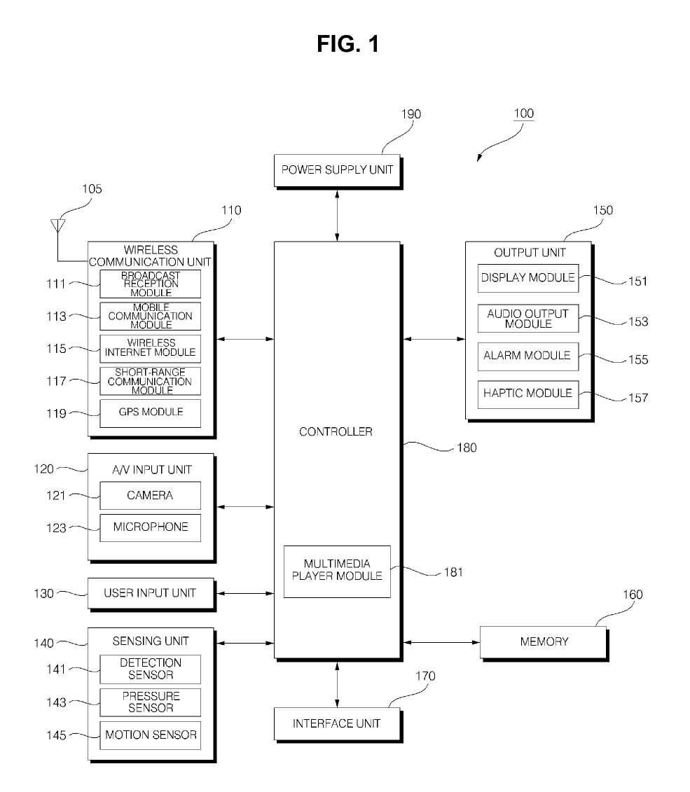

FIG. 1 illustrates a block diagram of a mobile terminal 100 according to an embodiment of the present invention. Referring to FIG. 1, the mobile terminal 100 can include a wireless communication unit 110, an audio/video (A/V) input unit 120, a user input unit 130, a sensing unit 140, an output unit 150, a memory 160, an interface unit 170, a controller 180, and a power supply unit 190. Here, when the above constituent elements are implemented, two or more of the constituent elements can be combined into one constituent element, or one constituent element can be divided into two or more constituent elements, if appropriate.

The wireless communication unit 110 can include a broadcast reception module 111, a mobile communication module 113, a wireless internet module 115, a short-range communication module 117, and a global positioning system (GPS) module 119.

The broadcast reception module 111 can receive broadcast signals and/or broadcast-related information from an external broadcast management server through a broadcast channel. The broadcast channel can be a satellite channel or a terrestrial channel. The broadcast management server can be a server which generates broadcast signals and/or broadcast-related information and transmits the generated broadcast signals and/or the generated broadcast-related information or can be a server which receives and then transmits previously-generated broadcast signals and/or previously-generated broadcast-related information.

The broadcast-related information can include broadcast channel information, broadcast program information and/or broadcast service provider information. The broadcast signals can include a TV broadcast signal, a radio broadcast signal, a data broadcast signal, the combination of a data broadcast signal and a TV broadcast signal or the combination of a data broadcast signal and a radio broadcast signal. The broadcast-related information can be provided to the mobile terminal 100 through a mobile communication network. In this instance, the broadcast-related information can be received by the mobile communication module 113, rather than by the broadcast reception module 111. The broadcast-related information can come in various forms. For example, the broadcast-related information can come in the form of digital multimedia broadcasting (DMB) electronic program guide (EPG) or digital video broadcasting-handheld (DVB-H) electronic service guide (ESG).

The broadcast reception module 111 can receive broadcast signals using various broadcasting systems, such as DMB-terrestrial (DMB-T), DMB-satellite (DMB-S), media forward link only (MediaFLO), DVB-H, and integrated services digital broadcast-terrestrial (ISDB-T). In addition, the broadcast reception module 111 can be suitable not only for the above-mentioned digital broadcasting systems but also for nearly all types of broadcasting systems other than those set forth herein. The broadcast signal and/or the broadcast-related information received by the broadcast reception module 111 can be stored in the memory 160.

The mobile communication module 113 can transmit wireless signals to or receives wireless signals from at least one of a base station, an external terminal, and a server through a mobile communication network. The wireless signals can include various types of data according to whether the mobile terminal 100 transmits/receives voice call signals, video call signals, or text/multimedia messages.

The wireless internet module 115 can be a module for wirelessly accessing the internet. The wireless internet module 115 can be embedded in the mobile terminal 100 or can be installed in an external device. The wireless internet module 115 can be embedded in the mobile terminal 100 or can be installed in an external device. The wireless internet module 115 can use various wireless internet technologies such as wireless local area network (WLAN), Wireless Broadband (WiBro), World Interoperability for Microwave Access (Wimax), and High Speed Downlink Packet Access (HSDPA).

The short-range communication module 117 can be a module for short-range communication. The short-range communication module 117 can use various short-range communication techniques such as Bluetooth, radio frequency identification (RFID), infrared data association (IrDA), ultra wideband (UWB), and ZigBee.

The GPS module 119 can receive position information from a plurality of GPS satellites.

The A/V input unit 120 can be used to receive audio signals or video signals. The A/V input unit 120 can include a camera module 121 and a microphone 123. The camera module 121 can process various image frames such as still images or moving images acquired by an image sensor during a video call mode or an image capturing mode. The image frames processed by the camera module 121 can be displayed by a display module 151.

The image frames processed by the camera module 121 can be stored in the memory 160 or can be transmitted to an external device through the wireless communication unit 110. The mobile terminal 100 can include two or more cameras 121.

The microphone 123 can receive external audio signals during a call mode, a recording mode, or a voice recognition mode and can convert the received sound signals into electrical audio data. During the call mode, the mobile communication module 113 can convert the electrical sound data into data that can be readily transmitted to a mobile communication base station, and can then output the data obtained by the conversion. The microphone 123 can use various noise removal algorithms to remove noise that can be generated during the reception of external sound signals.

The user input unit 130 can generate key input data based on user input for controlling the operation of the mobile terminal 100. The user input unit 130 can be implemented as a keypad, a dome switch, or a static pressure or capacitive touch pad which is capable of receiving a command or information by being pushed or touched by a user. Alternatively, the user input unit 130 can be implemented as a wheel, a jog dial or wheel, or a joystick capable of receiving a command or information by being rotated. Still alternatively, the user input unit 130 can be implemented as a finger mouse. In particular, if the user input unit 130 is implemented as a touch pad and forms a mutual layer structure with the display module 151, the user input unit 130 and the display module 151 can be collectively referred to as a touch screen.

The sensing unit 140 can determine a current state of the mobile terminal 100 such as whether the mobile terminal 100 is opened or closed, the position of the mobile terminal 100 and whether the mobile terminal 100 is placed in contact with the user, and can generate a sensing signal for controlling the operation of the mobile terminal 100. For example, when the mobile terminal 100 is a slider-type mobile phone, the sensing unit 140 can determine whether the mobile terminal 100 is opened or closed. In addition, the sensing unit 140 can determine whether the mobile terminal 100 is powered by the power supply unit 190 and whether the interface unit 170 is connected to an external device.

The sensing unit 140 can include a detection sensor 141, a pressure sensor 143 and a motion sensor 145. The detection sensor 141 can detect an approaching object or whether there is an object nearby the mobile terminal 100 without mechanical contact. More specifically, the detection sensor 141 can detect an approaching object based on a change in an alternating current (AC) magnetic field or a static magnetic field, or the rate of change of capacitance. The sensing unit 140 can include two or more detection sensors 141.

The pressure sensor 143 can determine whether pressure is being applied to the mobile terminal 100 or can measure the magnitude of pressure, if any, applied to the mobile terminal 100. The pressure sensor 143 can be installed in a certain part of the mobile terminal 100 where the detection of pressure is used. For example, the pressure sensor 143 can be installed in the display module 151. In this instance, it is possible to differentiate a typical touch input from a pressure touch input, which is generated by applying greater pressure than that used to generate a typical touch input, based on a signal output by the pressure sensor 143. In addition, it is possible to determine the magnitude of pressure applied to the display module 151 upon receiving a pressure touch input based on the signal output by the pressure sensor 143.

The motion sensor 145 can determine the location and motion of the mobile terminal 100 using an acceleration sensor or a gyro sensor.

In the meantime, acceleration sensors are a type of device for converting a vibration in acceleration into an electric signal. With recent developments in micro-electromechanical system (MEMS) technology, acceleration sensors have been widely used in various products for various purposes ranging from detecting large motions such as car collisions as performed in airbag systems for automobiles to detecting minute motions such as the motion of the hand as performed in gaming input devices. In general, two or more acceleration sensors representing different axial directions are incorporated into a single package. There are some instances when the detection of only one axial direction, for example, a Z-axis direction, is used. Thus, when an X- or Y-axis acceleration sensor, instead of a Z-axis acceleration sensor, is used, the X- or Y-axis acceleration sensor can be mounted on an additional substrate, and the additional substrate can be mounted on a main substrate.

Gyro sensors are sensors for measuring angular velocity, and can determine the relative direction of the rotation of the mobile terminal 100 to a reference direction.

The output unit 150 can output audio signals, video signals and alarm signals. The output unit 150 can include the display module 151, an audio output module 153, an alarm module 155, and a haptic module 157.

The display module 151 can display various information processed by the mobile terminal 100. For example, if the mobile terminal 100 is in a call mode, the display module 151 can display a user interface (UI) or a graphic user interface (GUI) for making or receiving a call. If the mobile terminal 100 is in a video call mode or an image capturing mode, the display module 151 can display a UI or a GUI for capturing or receiving images.

If the display module 151 and the user input unit 130 form a mutual layer structure and are thus implemented as a touch screen, the display module 151 can be used not only as an output device but also as an input device capable of receiving information by being touched by the user.

If the display module 151 is implemented as a touch screen, the display module 151 can also include a touch screen panel and a touch screen panel controller. The touch screen panel is a transparent panel attached onto the exterior of the mobile terminal 100 and can be connected to an internal bus of the mobile terminal 100. The touch screen panel keeps monitoring whether the touch screen panel is being touched by the user. Once a touch input to the touch screen panel is received, the touch screen panel transmits a number of signals corresponding to the touch input to the touch screen panel controller. The touch screen panel controller processes the signals transmitted by the touch screen panel, and transmits the processed signals to the controller 180. Then, the controller 180 determines whether a touch input has been generated and which part of the touch screen panel has been touched based on the processed signals transmitted by the touch screen panel controller.

The display module 151 can include electronic paper (e-paper). E-paper is a type of reflective display technology and can provide as high resolution as ordinary ink on paper, wide viewing angles, and excellent visual properties. E-paper can be implemented on various types of substrates such as a plastic, metallic or paper substrate and can display and maintain an image thereon even after power is cut off. In addition, e-paper can reduce the power consumption of the mobile terminal 100 because it does not require a backlight assembly. The display module 151 can be implemented as e-paper by using electrostatic-charged hemispherical twist balls, using electrophoretic deposition, or using microcapsules.

The display module 151 can include at least one of an LCD, a thin film transistor (TFT)-LCD, an organic light-emitting diode (OLED), a flexible display, and a three-dimensional (3D) display. The mobile terminal 100 can include two or more display modules 151. For example, the mobile terminal 100 can include an external display module and an internal display module.

The audio output module 153 can output audio data received by the wireless communication unit 110 during a call reception mode, a call mode, a recording mode, a voice recognition mode, or a broadcast reception mode or can output audio data present in the memory 160. In addition, the audio output module 153 can output various sound signals associated with the functions of the mobile terminal 100 such as receiving a call or a message. The audio output module 153 can include a speaker and a buzzer.

The alarm module 155 can output an alarm signal indicating the occurrence of an event in the mobile terminal 100. Examples of the event include receiving a call signal, receiving a message, and receiving a key signal. Examples of the alarm signal output by the alarm module 155 include an audio signal, a video signal and a vibration signal. More specifically, the alarm module 155 can output an alarm signal upon receiving an incoming call or message. In addition, the alarm module 155 can receive a key signal and can output an alarm signal as feedback to the key signal. Therefore, the user can easily recognize the occurrence of an event based on an alarm signal output by the alarm module 155. An alarm signal for notifying the user of the occurrence of an event can be output not only by the alarm module 155 but also by the display module 151 or the audio output module 153.

The haptic module 157 can provide various haptic effects (such as vibration) that can be perceived by the user. If the haptic module 157 generates vibration as a haptic effect, the intensity and the pattern of vibration generated by the haptic module 157 can be altered in various manners. The haptic module 157 can synthesize different vibration effects and can output the result of the synthesization. Alternatively, the haptic module 157 can sequentially output different vibration effects.

The haptic module 157 can provide various haptic effects, other than vibration, such as a haptic effect obtained using a pin array that moves perpendicularly to a contact skin surface, a haptic effect obtained by injecting or sucking in air through an injection hole or a suction hole, a haptic effect obtained by giving a stimulus to the surface of the skin, a haptic effect obtained through contact with an electrode, a haptic effect obtained using an electrostatic force, and a haptic effect obtained by realizing the sense of heat or cold using a device capable of absorbing heat or generating heat. The haptic module 157 can be configured to enable the user to recognize a haptic effect using the kinesthetic sense of the fingers or the arms. The mobile terminal 100 can include two or more haptic modules 157.

The memory 160 can store various programs used for the operation of the controller 180. In addition, the memory 160 can temporarily store various data such as a list of contacts, messages, still images, or moving images.

The memory 160 can include at least one of a flash memory type storage medium, a hard disk type storage medium, a multimedia card micro type storage medium, a card type memory (e.g., a secure digital (SD) or extreme digital (XD) memory), a random access memory (RAM), and a read-only memory (ROM). The mobile terminal 100 can operate a web storage, which performs the functions of the memory 160 on the internet.

The interface unit 170 can interface with an external device that can be connected to the mobile terminal 100. The interface unit 170 can be a wired/wireless headset, an external battery charger, a wired/wireless data port, a card socket for, for example, a memory card, a subscriber identification module (SIM) card or a user identity module (UIM) card, an audio input/output (I/O) terminal, a video I/O terminal, or an earphone. The interface unit 170 can receive data from an external device or can be powered by an external device. The interface unit 170 can transmit data provided by an external device to other components in the mobile terminal 100 or can transmit data provided by other components in the mobile terminal 100 to an external device.

When the mobile terminal 100 is connected to an external cradle, the interface unit 170 can provide a path for supplying power from the external cradle to the mobile terminal 100 or for transmitting various signals from the external cradle to the mobile terminal 100.

The controller 180 can control the general operation of the mobile terminal 100. For example, the controller 180 can perform various control operations regarding making/receiving a voice call, transmitting/receiving data, or making/receiving a video call. The controller 180 can include a multimedia player module 181, which plays multimedia data. The multimedia player module 181 can be implemented as a hardware device and can be installed in the controller 180. Alternatively, the multimedia player module 181 can be implemented as a software program.

The power supply unit 190 can be supplied with power by an external power source or an internal power source and can supply power to the other components in the mobile terminal 100. The mobile terminal 100 can include a wired/wireless communication system or a satellite communication system and can thus operate in a communication system capable of transmitting data in units of frames or packets.

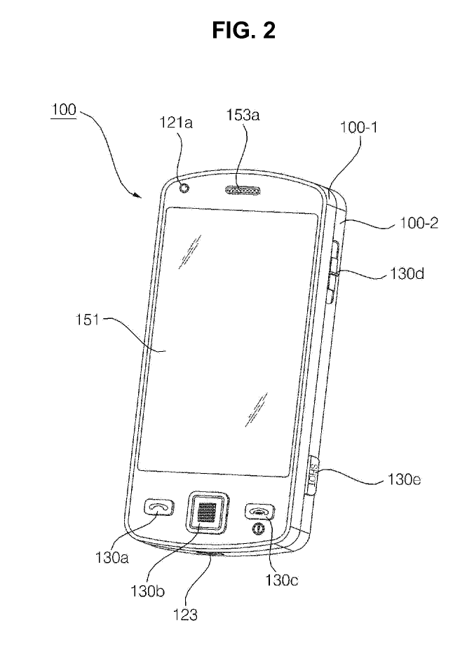

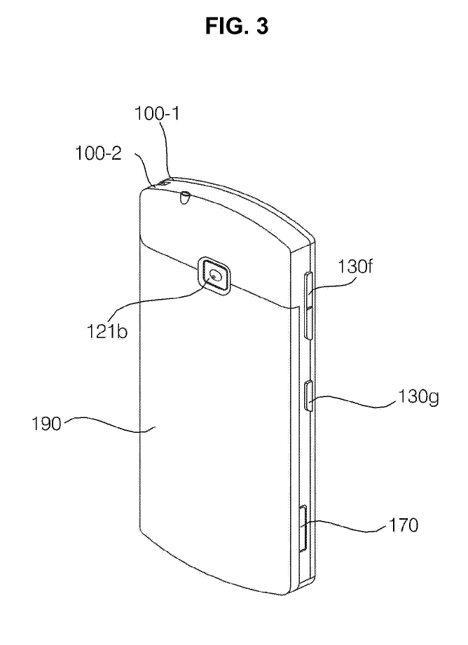

The exterior of the mobile terminal 100 will hereinafter be described in detail with reference to FIGS. 2 and 3. The present invention can be applied to nearly all types of mobile terminals such as a folder-type, a bar-type, a swing-type and a slider-type mobile terminal. However, for convenience, it is assumed that the mobile terminal 100 is a bar-type mobile terminal equipped with a full touch screen.

FIG. 2 illustrates a front perspective view of the mobile terminal 100. Referring to FIG. 2, the exterior of the mobile terminal 100 can be formed by a front case 100-1 and a rear case 100-2. Various electronic devices can be installed in the space formed by the front case 100-1 and the rear case 100-2. The front case 100-1 and the rear case 100-2 can be formed of a synthetic resin through injection molding. Alternatively, the front case 100-1 and the rear case 100-2 can be formed of a metal such as stainless steel (STS) or titanium (Ti).

The display module 151, a first audio output module 153a, a first camera 121a, and first through third user input modules 130a through 130c can be disposed in the main body of the mobile terminal 100, and particularly, in the front case 100-1. Fourth and fifth user input modules 130d and 130e and the microphone 123 can be disposed on one side of the rear case 100-2. If a touch pad is configured to overlap the display module 151 and thus to form a mutual layer structure, the display module 151 can serve as a touch screen and can thus allow the user to enter various information simply by touching the display module 151.

The first audio output module 153a can be implemented as a receiver or a speaker. The first camera 121 a can be configured to be suitable for capturing a still or moving image of the user. The microphone 123 can be configured to properly receive the user's voice or other sounds. The first through fifth user input modules 130a through 130e and sixth and seventh user input modules 130f and 130g can be collectively referred to as the user input unit 130. The user input unit 130 can adopt various tactile manners as long as it can offer tactile feedback to the user.

For example, the user input unit 130 can be implemented as a dome switch or touch pad capable of receiving a command or information by being pushed or touched by the user; or a wheel, a jog dial or wheel, or a joystick capable of receiving a command or information by being rotated. More specifically, the first through third user input modules 130a through 130c can be used to make or receive a call, move a mouse pointer, scroll a display screen, and enter various commands such as ‘start’, ‘end’, and ‘scroll’ to the mobile terminal 100, the fourth user input module 130d can be used to select an operation mode for the mobile terminal 100, and the fifth user input module 130e can serve as a hot key for activating certain functions of the mobile terminal 100.

FIG. 3 illustrates a rear perspective view of the mobile terminal 100. Referring to FIG. 3, a second camera 121b can be disposed at the rear of the rear case 100-2. The sixth and seventh user input modules 130f and 130e and the interface unit 170 can be disposed on one side of the second body 100B.

The second camera 121b can have a different photographing direction from the first camera 121a shown in FIG. 2. In addition, the first and second cameras 121a and 121b can have different resolutions.

A camera flash and a mirror can be disposed near the second camera 121b. The camera flash can be used to illuminate a subject when the user attempts to capture an image of the subject with the second camera 12 lb. The mirror can be employed by the user to prepare him or her self for taking a self shot.

A second audio output module can be additionally provided in the rear case 100-2. The second audio output module can realize a stereo function along with the first audio output module 153a. The second audio output module can also be used in a speaker-phone mode. The interface unit 170 can serve as a pathway for allowing the mobile terminal 100 to exchange data with an external device.

Not only an antenna for making or receiving a call but also an antenna for receiving a broadcast signal can be disposed on one side of the rear case 100-2. The antennas can be installed so as to be retracted from the rear case 100-2. The power supply unit 190, which supplies power to the mobile terminal 100, can be disposed in the rear case 100-2. The power supply unit can be a rechargeable battery and can be coupled to the rear case 100-2 so as to be attachable to or detachable from the rear case 100-2.

The second camera 121b and the other elements that have been described as being provided in the rear case 100-2 can be provided in the front case 100-1. In addition, the first camera 121a can be configured to be rotatable and thus to cover the photographing direction of the second camera 121b. In this instance, the second camera 121b can be optional.

Definitions of Basic Terms

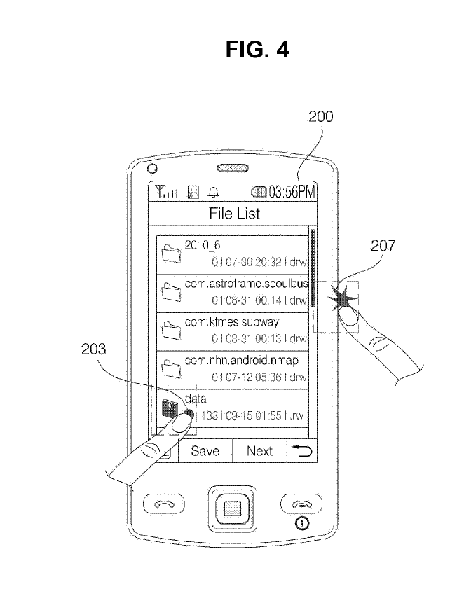

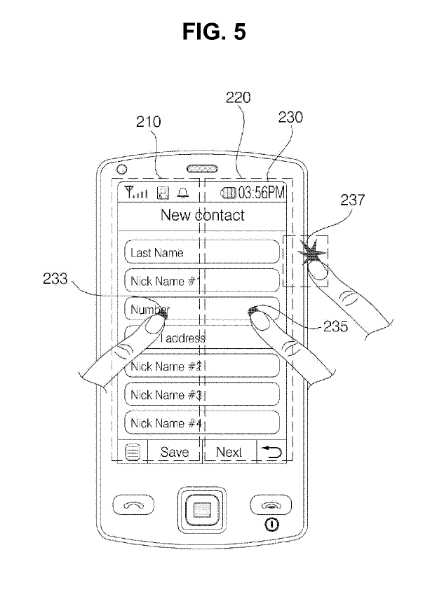

FIGS. 4 and 5 illustrate diagrams for explaining the terms used in the description of the present invention. Referring to FIG. 4, a touch 203 on an operation screen 200 on a display module 151, which is equipped in the main body of the mobile terminal 100, can be defined as a touch input, and a tap 207 on the main body of the mobile terminal 100 can be defined as a tap input.

The mobile terminal 100 can be configured to perform a predefined operation in response to a tap input being detected from the main body thereof. More specifically, the mobile terminal 100 can be configured to perform different functions according to a position of the detection of a tap input or a number of times of detection of a tap input.

Referring to FIG. 5, an operation screen 230 can be vertically divided into at least two sections: a first sub-screen 210 on the left side of the operation screen 230 and a second sub-screen 220 on the right side of the operation screen 230. A user input including first and second touch inputs 233 and 235 detected from the first and second sub-screens 210 and 220, respectively, can be defined as a multi-touch input.

The first and second sub-screens 210 and 220 can have the same size or different sizes. As another example, the operation screen 230 can be horizontally divided into upper and lower sub-screens. A user input including first and second touch inputs detected from the upper and lower sub-screens, respectively, can also be defined as a multi-touch input.

Even in a situation in which the operation screen 230 is divided into two sub-screens, a tap 237 on the main body of the mobile terminal 100 can be defined as a tap input.

Embodiments Related to List

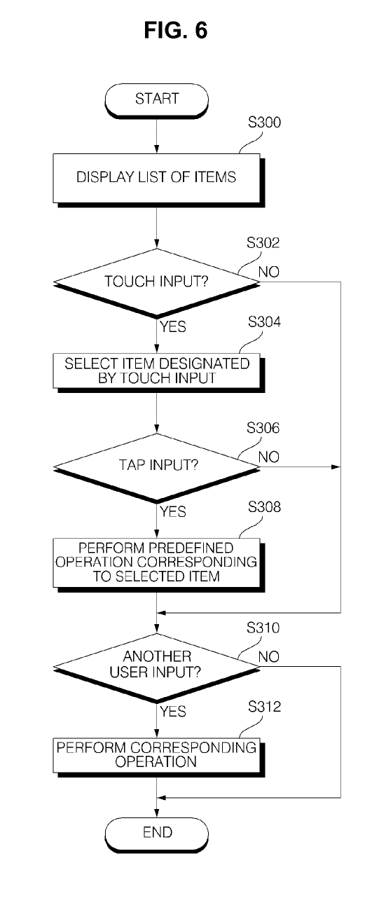

Next, FIG. 6 illustrates a flowchart of an operation control method of a mobile terminal, according to an embodiment of the present invention. Referring to FIG. 6, if a menu such as a phonebook menu, a mail inbox/outbox menu, an MP3 player menu, a video player menu or an image viewer menu is selected in response to, for example, a user command, being received, the controller 180 can display a list screen showing a list of items relevant to the selected menu on the display module 151, which includes a touch screen (S300).

In response to a touch input being detected from the list screen (Yes in S302), the controller 180 selects an item designated by the touch input from the list screen (S304). The controller 180 can select more than one item from the list screen in response to a multi-touch input or more than one touch being detected from the list screen.

The controller 180 can display a selected item differently from other non-selected items so as for the selected item to be easily distinguishable. The controller 180 can generate a haptic effect in response to one of the items being selected from the list screen.

In response to a tap input being detected from the main body of the mobile terminal 100 (Yes in S306), the controller 180 controls a predefined operation corresponding to the selected item to be performed (S308). Examples of the predefined operation include, but are not limited to, executing, deleting, moving, copying, and cutting the selected item. Different operations can be performed in connection with the selected item according to a part of the mobile terminal 100 has been tapped and the number of times the mobile terminal 100 has been tapped.

In response to a user input (such as a key input), other than a touch input, being detected from the list screen (Yes in S310), the controller 180 controls an operation corresponding to the detected user input to be performed (S312).

According to this embodiment, it is possible to select an item from a list screen in response to a touch input being detected from the list screen, and perform a predefined operation corresponding to the selected item in response to a tap input being detected from the main body of the mobile terminal 100.

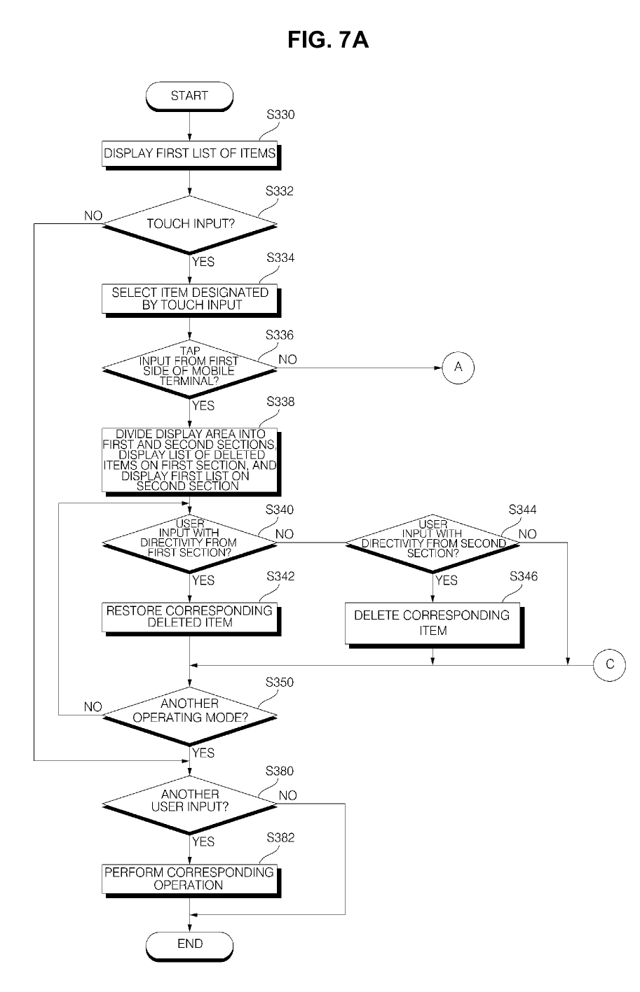

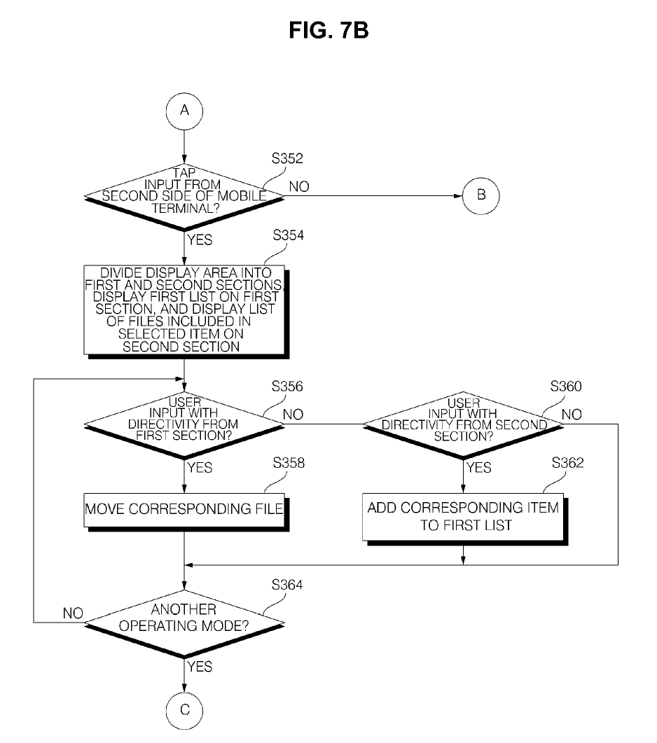

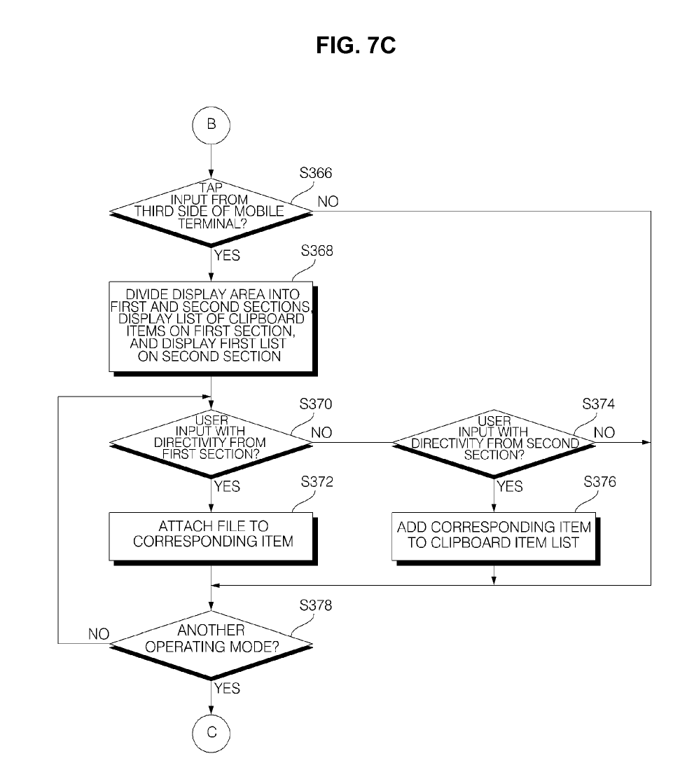

Next, FIGS. 7A through 7C illustrate flowcharts of an operation control method of a mobile terminal, according to another embodiment of the present invention. Referring to FIG. 7A, the controller 180 can display a list screen showing a first list including a plurality of items that are relevant to a current operation mode selected in response to, for example, a user command, on the display module 151, which includes a touch screen (S330).

In response to a touch input being detected from the list screen (Yes in S332), the controller 180 selects an item designated by the touch input from the list screen (S334). The controller 180 can select more than one item from the list screen in response to a multi-touch input or more than one touch being detected from the list screen.

In response to a tap input being detected from a first side (e.g., the left side) of the mobile terminal 100 (Yes in S336), the controller 180 vertically divides the display area on the display module 151 into first and second sections, displays a list of deleted items on the first section, and displays the first list excluding the selected item on the second section (S338). The list displayed on the first section can include the selected item. In response to no tap input being detected from the first side of the mobile terminal 100 (No in S336), the operation control method proceeds to A.

In response to a user input with directivity such as a touch-and-drag and a flick being detected from one of the items in the list displayed on the first section (Yes in S340), the controller 180 restores the item designated by the detected user input (S342). The restored item can be added to the first list displayed on the second section.

The term ‘flick input’ indicates, but is not limited to, a user input generated by scratching the surface of the display module 151 lightly with a finger. A flick input and a typical touch input can be distinguished from each other by the duration for which the user touches the surface of the display module 151 with a finger.

In response to a user input with directivity such as a touch-and-drag or a flick being detected from one of the items in the first list displayed on the second section (Yes in S344), the controller 180 deletes the item designated by the detected user input (S346). The deleted item can be added to the list displayed on the first screen.

Operations S340 through S346 are repeatedly performed until another operating mode is selected (Yes in S350). In response to another user input being detected (Yes in S380), the controller 180 controls an operation corresponding to the user input detected in operation S380 to be performed (S382).

Referring to FIG. 7B, in response to a tap input being detected from a second side (e.g., the right side) of the mobile terminal 100 (Yes in S352), the controller 180 vertically divides the display area on the display module 151 into first and second sections, displays the first list on the first section, and displays a second list including one or more files included in the selected item on the second section (S354). In response to no tap input being detected from the second side of the mobile terminal 100 (No in S352), the operation control method proceeds to B.

In response to a user input with directivity such as a touch-and-drag or a flick being detected from one of the items in the first list (Yes in S356), the controller 180 controls the files in the second list to be included in the item designated by the detected user input (S358). In response to a user input with directivity such as a touch-and-drag or a flick being detected from one of the items in the second list (Yes in S360), the controller 180 controls the item designated by the detected user input to be added to the first list (S362). Operations S356 through S362 are repeatedly performed until another operating mode is selected (Yes in S364).

Referring to FIG. 7C, in response to a tap input being detected from a third side (e.g., the upper side) of the mobile terminal 100 (Yes in S366), the controller 180 vertically divides the display area on the display module 151 into first and second sections, displays a list of clipboard items including the selected item on the first section, and displays the first list on the second section (S368).

In response to a user input with directivity such as a touch-and-drag or a flick being detected from the first section (Yes in S370), the controller 180 controls a clipboard item designated by the detected user input to be added to one of the items in the first list as an attachment (S372). In response to a user input with directivity such as a touch-and-drag or flick being detected from one of the items in the first list (Yes in S374), the controller 180 controls the item designated by the detected user input to be added to the list displayed on the first section (S376). Operations S370 through S376 are repeatedly performed until another operating mode is selected (Yes in S378).

As described above with reference to FIGS. 7A through 7C, it is possible to easily select an item from a list using a touch input, and divide the display area on the display module 151 into more than one section and perform various operations in connection with the selected item using a tap input.

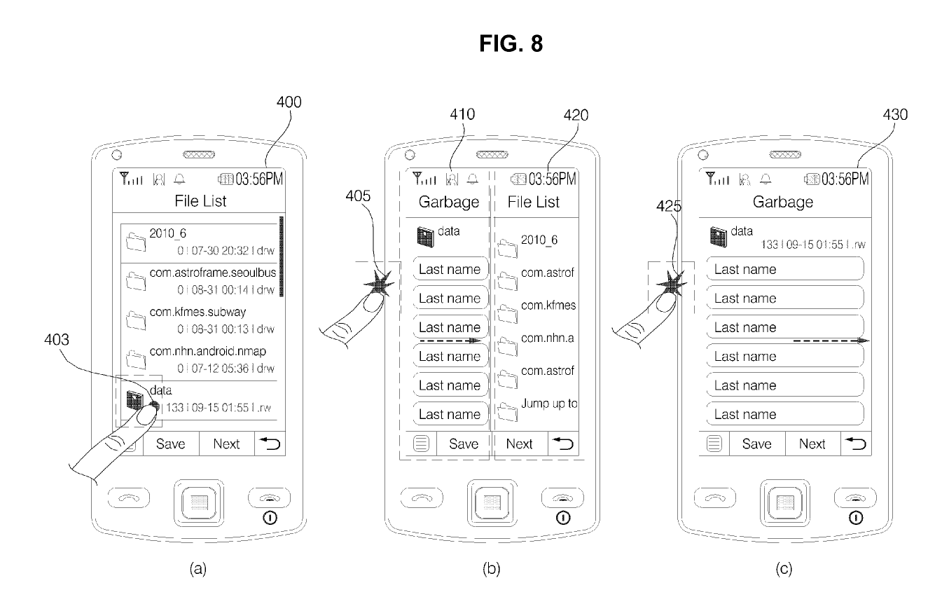

Next, FIGS. 8 through 10 illustrate the embodiment of FIGS. 7A through 7C, and more particularly, how to perform a predefined function corresponding to an item selected from a list screen in response to a touch input and a tap input being detected from the list screen.

Referring to FIG. 8(a), in response to a touch input 403 being detected from a list screen 400 showing a first list including a plurality of items, one of the plurality of items designated by the touch input 403 can be selected. Thereafter, referring to FIG. 8(b), in response to a tap input 405 being detected from the left side of the mobile terminal 100, the display area on the display module 151 can be divided into first and second sections 410 and 420, a list of deleted items including the selected item can be displayed on the first section 410, and the first list excluding the selected item can be displayed on the second section 420.

Referring to FIG. 8(c), in response to another tap input 425 being detected from the left side of the mobile terminal 100, a display screen 430 can be displayed, and the list of deleted items can be displayed as a full screen on the entire display module 151. In response to a tap input being detected twice in a row from the left side of the mobile terminal 100, the list of deleted items can be readily displayed as a full screen on the entire display module 151 without being subjected to screen division.

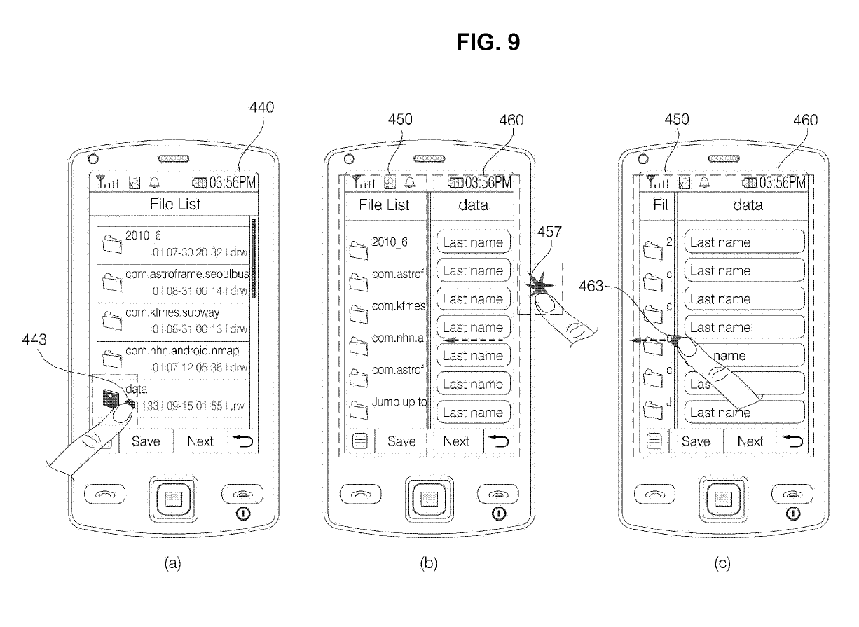

Referring to FIG. 9(a), in response to a touch input 443 being detected from a list screen 440 showing a list of a plurality of items, one of the plurality of items can be selected. Then, referring to FIG. 9(b), in response to a tap input 457 being detected from the right side of the mobile terminal 100, the display area on the display module 151 can be vertically divided into first and second sections 450 and 460, the list previously displayed on the list screen 440 can be displayed on the first section 450, and a list of files included in the selected item can be displayed on the second section 460.

Referring to FIG. 9(c), in response to a right-to-left drag 463 being detected from the border between the first and second sections 450 and 460, the size of the first section 450 can be reduced, and the size of the second section 460 can be increased. On the other hand, in response to a left-to-right drag being detected from the border between the first and second sections 450 and 460, the size of the first section 450 can be increased, and the size of the second section 460 can be reduced.

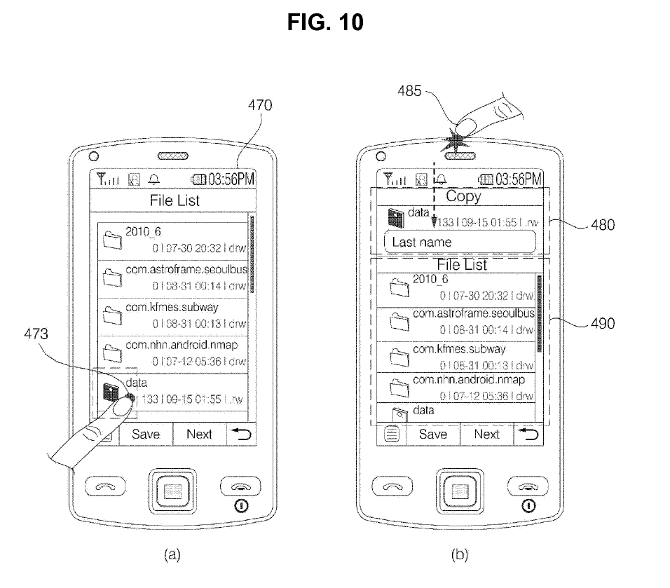

Referring to FIG. 10(a), in response to a touch input 473 being detected from a list screen 470 showing a list of a plurality of items, one of the plurality of items can be selected. Then, referring to FIG. 10(b), in response to a tap input 485 being detected from the upper side of the mobile terminal 100, the display area on the display module 151 can be horizontally divided into first and second sections 480 and 490, a list of clipboard items including the selected item can be displayed on the first section 480, and the list previously displayed on the list screen 470 can be displayed on the second section 490.

In response to another tap input being detected from the upper side of the mobile terminal 100, the list clipboard items including the selected item can be displayed as a full screen on the entire display module 151.

Similarly, in response to a tap input being detected twice in a row from the upper side of the mobile terminal 100, the list of clipboard items including the selected item can be readily displayed as a full screen on the entire display module 151 without being subjected to screen division.

Embodiments Related to Idle Screen and Menu

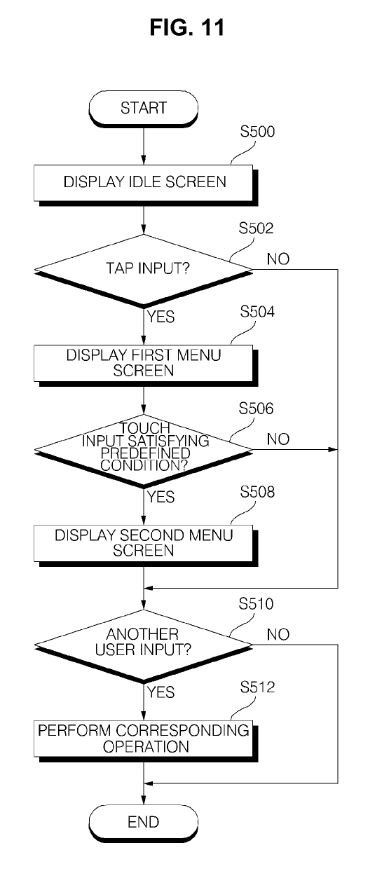

FIG. 11 illustrates a flowchart of an operation control method of a mobile terminal, according to another embodiment of the present invention. Referring to FIG. 11, the controller 180 can display an idle screen on the display module 151 after the mobile terminal 100 is booted up or released from a lock mode or if no user input is detected for more than a predefined amount of time (S500). In response to a tap input being detected from one part of the mobile terminal 100 (Yes in S502), the controller 180 displays a first menu screen on the display module 151 (S504).

The user can select each menu icon displayed on the first menu and can thus perform a corresponding operation. If more than one menu icon is selected from the first menu screen, a number of operations respectively corresponding to the selected menu icons can be performed one after another, and a number of operation screens relevant to the performing of the operations can be displayed on the display module 151 or can be displayed as virtual screens.

In response to a tap input that satisfies a predefined condition being detected when the first menu screen is displayed (Yes in S506), the controller 180 displays a second menu screen on the display module 151 (S508). A tap input that satisfies the predefined condition can be a tap input that satisfies a tap strength or tap frequency requirement. The controller 180 can be configured to display the first menu screen only in response to a tap input satisfying the predefined condition being detected from an idle screen.

The first and second menu screens can be selected by the user. For this, a menu for selecting what menu screens should be displayed as the first and second menu screens can be provided. In response to a user input (such as a key input), other than a touch input, being detected from the idle screen or the second menu screen (Yes in S510), the controller 180 controls an operation corresponding to the detected user input to be performed (S512).

According to this embodiment, it is possible to easily display a menu screen or navigate from one menu screen to another menu screen in response to a tap input being detected from the main body of the mobile terminal 100 when an idle screen is displayed on the display module 151.

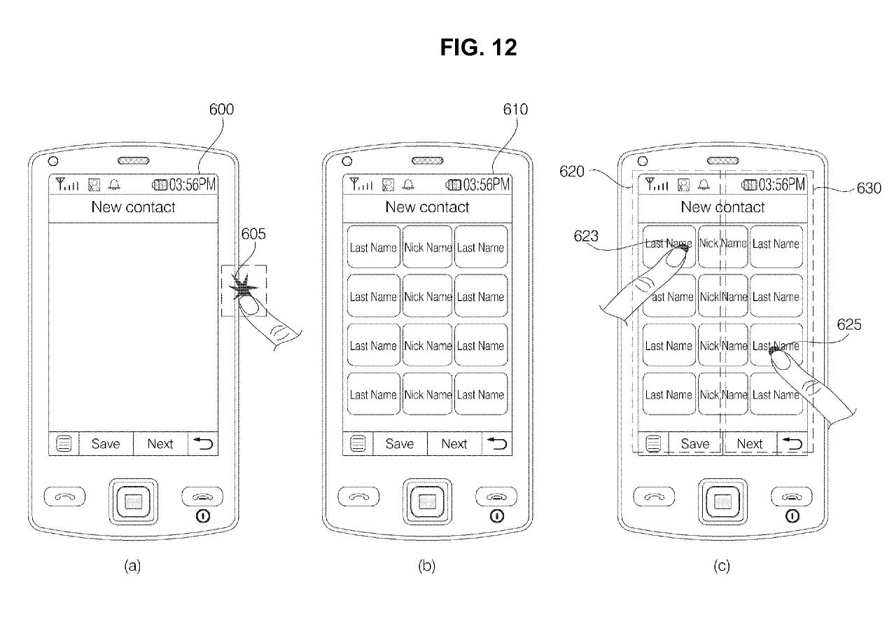

The embodiment of FIG. 11 will hereinafter be described in further detail with reference to FIG. 12. In particular, FIG. 12 illustrates how to display a menu screen or navigate from one menu screen to another menu screen in response to a tap input being detected from the main body of the mobile terminal 100 when an idle screen is displayed on the display module 151.

Referring to FIGS. 12(a) and 12(b), in response to a tap input 605 being detected from the right side of the mobile terminal 100 when an idle screen 600 is displayed, a menu screen 610 can be displayed on the display module 151. It can be set in advance what menu screen should be displayed in response to a tap input.

In response to a tap input satisfying a predefined condition being detected from the mobile terminal 100 when the menu screen 610 is displayed on the display module 151, another menu screen can be displayed on the display module 151.

Referring to FIG. 12(c), in response to more than one icon being selected by a multi-touch input including first and second touch inputs 623 and 630 detected from first and second sections 620 and 630, respectively, on a menu screen 630, operations corresponding to the selected icons can be performed one after another, and at least one of display screens relevant to the operations can be displayed as a virtual screen.

In response to a multi-touch input being detected from the idle screen 600, a ‘Modify Settings’ menu can be displayed on the display module 151. Examples of settings information that can be modified using the ‘Modify Settings’ menu include, but are not limited to, background settings information, control-related information, event-related information and other user settings information.

Embodiments Related to Camera Function

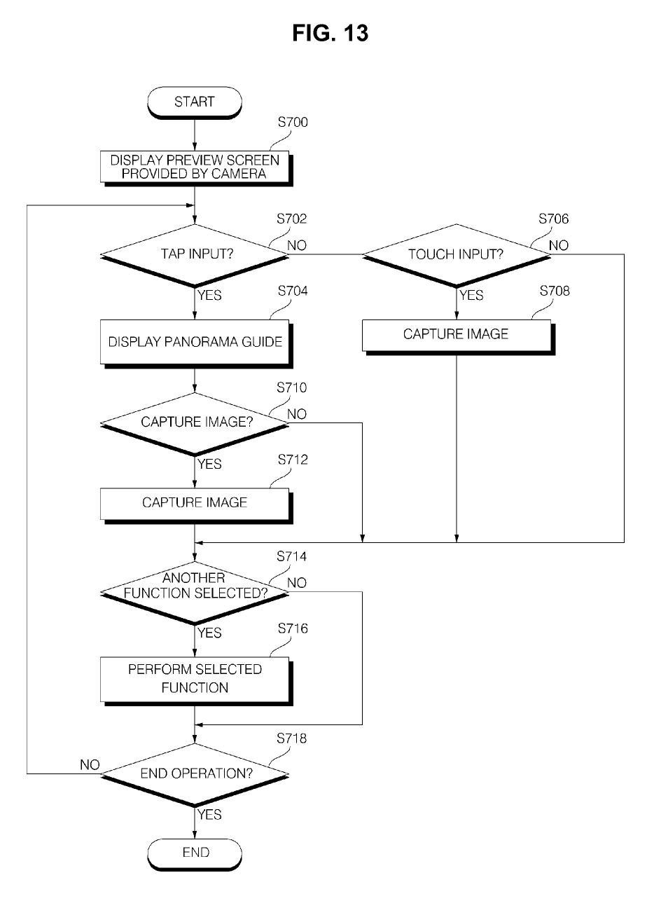

FIG. 13 illustrates a flowchart of an operation control method of a mobile terminal, according to another embodiment of the present invention. Referring to FIG. 13, if a camera mode is selected in response to, for example, a user command, the controller 180 displays a preview screen showing a preview image provided by the camera module 121 on the display module 151 (S700).

In response to a tap input being detected from one part of the mobile terminal 100 (Yes in S702), the controller 180 displays a panorama guide along a direction corresponding to a position of the detection of the tap input (S704). For example, the controller 180 can display a panorama guide in a direction from the left to the right in response to a tap input being detected from the right side of the mobile terminal 100, and can display the panorama guide in a direction from the right to the left in response to a tap input being detected from the left side of the mobile terminal 100.

A panorama mode is a mode for taking three or more pictures of the same place, stitching the three or more pictures into a panorama image and saving the panorama image. For this, a lattice guide can be displayed over the preview image. The lattice guide can also be useful for capturing a photo, capturing a plurality of photos in a row or capturing a self-portrait. In order to properly stitch a current image with a previous image in the panorama mode, the previous image can be partially displayed, instead of the panorama guide. In the panorama mode, not only landscape images but also portrait images can be stitched together.

In response to a tap input being detected from the mobile terminal 100, the camera 121 can be switched from one mode to another mode. For example, in response to a tap input being detected from the upper or lower side of the mobile terminal 100, the camera 121 can be switched from a video recording mode to a frame capture mode or to a barcode scanning mode.

In response to a user choosing to acquire an image (Yes in S710), the controller 180 controls the camera module 121 to acquire an image (S712). The acquired image can be displayed on the display module 151, instead of the preview screen. In response to a touch input being detected from the preview screen (Yes in S706), the controller 180 determines that the user has chosen to acquire an image, and controls the camera module 121 to acquire an image (S708). That is, the controller 180 can interpret a touch input detected from the preview screen as a command to acquire an image.

In response to a camera function, other than an image acquisition function, being selected (Yes in S714), the controller 180 controls the selected camera function to be performed (S716). For example, if the user multi-touches an image listed in a camera album with two fingers and then drags the image with one of the two fingers, the image can be zoomed in or out according to the distance by which it is dragged. Operations S702 through S716 can be repeatedly performed until the user chooses to end the camera mode (Yes in S718).

According to this embodiment, it is possible to display a panorama guide over a preview image or switch from one camera mode to another camera mode in response to a tap input being detected from the mobile terminal 100 when the preview image is displayed on the display module 151.

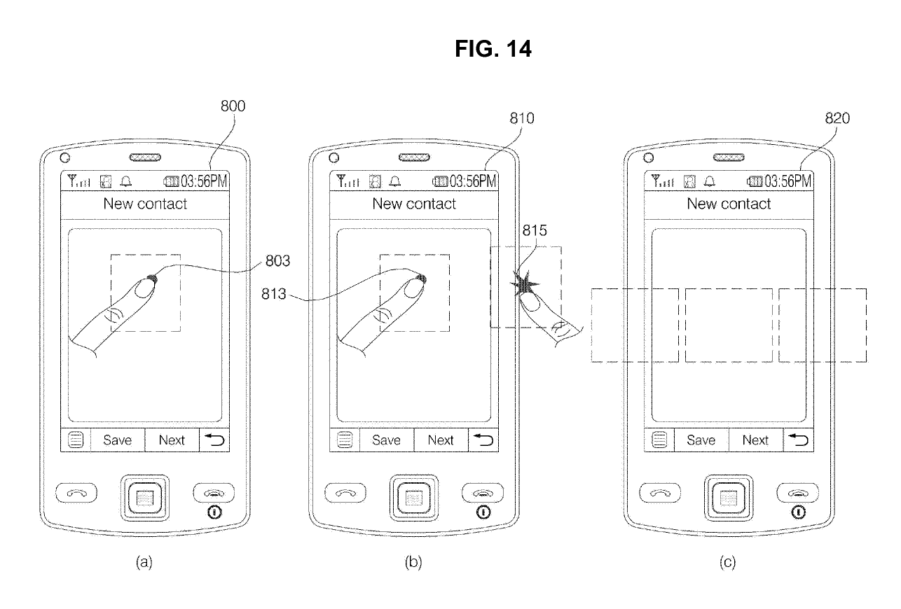

Next, FIG. 14 illustrates the embodiment of FIG. 13, and more particularly, how to control a camera function. Referring to FIG. 14(a), in response to a touch input 803 being detected from a preview screen 800, an image acquisition operation can be performed by displaying a preview screen 810 as shown in FIG. 14(b).

Referring to FIGS. 14(b) and 14(c), in response to a touch 813 on the preview screen 810 and a tap 815 on the right side of the mobile terminal 100 being detected, a display screen 820 showing a panorama guide can be displayed in a direction corresponding to the position of the detection of the tap 815.

In this manner, it is possible to control various camera-related operations in response to a tap input being detected from a preview screen.

Embodiments Related to Multitasking

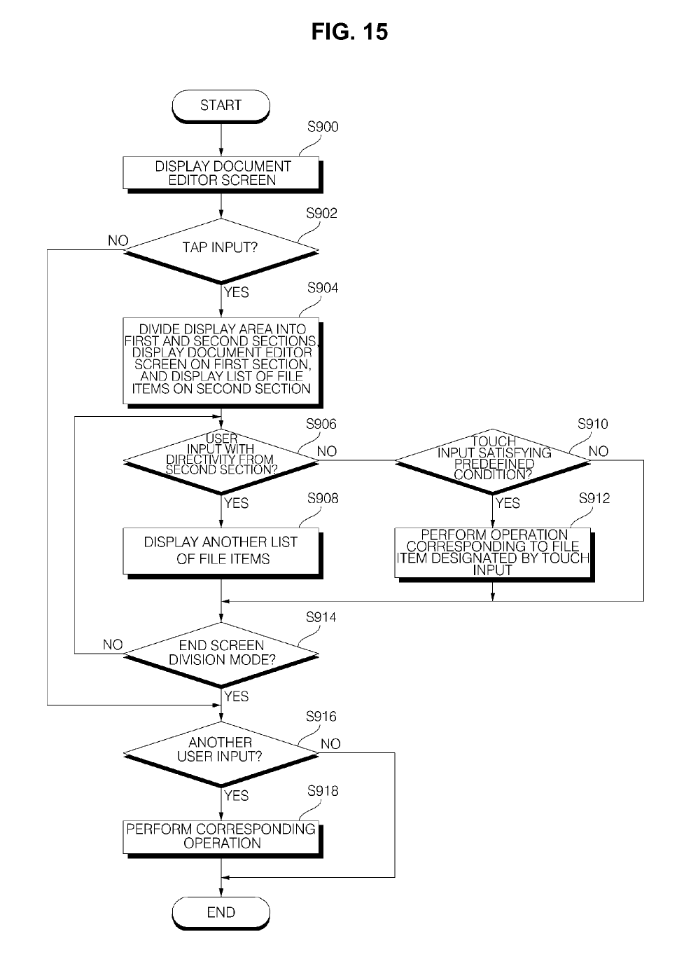

FIG. 15 illustrates a flowchart of an operation control method of a mobile terminal, according to another embodiment of the present invention. Referring to FIG. 15, if an operation menu such as ‘New Message’ is selected in response to, for example, a user command, the controller 180 displays a document editor screen for writing a new email or message, on the display module 151 (S900).

In response to a tap input being detected from the mobile terminal 100 (Yes in S902), the controller 180 vertically divides the display area on the display module 151 into first and second sections, displays the document editor screen on the first section, and displays a display screen showing a first set of files that can be attached to any document being written or edited on the document editor screen on the second section (S904). The files displayed on the second section can be identified by their file names or icons.

In response to a user input with directivity such as a flick input or a touch-and-drag input being detected from the second section (Yes in S906), the controller 180 either attaches one of the files displayed on the second section to the document in the document editor window or displays a second set of files, which is different from the first set of files, on the second section (S908).

For example, in response to one of the files displayed on the second section being touched and then flicked or dragged to the left, the corresponding file can be attached to the document in the document editor window. In response to a left-to-right flick being detected from the second section, a set of files, which is different from the first set of files, can be displayed on the second section.

In response to a touch input satisfying a predefined condition being detected from one of the files displayed on the second section (Yes in S910), the controller 180 executes the file designated by the touch input in a multitasking manner (S912). The predefined condition can specify a touch duration, touch area or touch pressure that should be met. The file designated by the touch input can be executed in the background, and an operation screen relevant to the execution of the corresponding file can be displayed on the entire second section or on part of the second section.

Operations S906 through S912 can be repeatedly performed until the user chooses to end a screen division mode (Yes in S914). More specifically, the screen division mode can be completed in response to a multi-touch input or a predefined key input being detected or in response to a predefined menu icon being selected.

In response to a user input (such as a key input) other than a touch input being detected (Yes in S916), the controller 180 controls an operation corresponding to the detected user input to be performed (S918).

According to this embodiment, it is possible to easily divide the display area on the display module 151, attach a file to a document or email or perform various functions other than creating a document or email in a multitasking manner in response to a multi-touch input detected from a document editor screen.

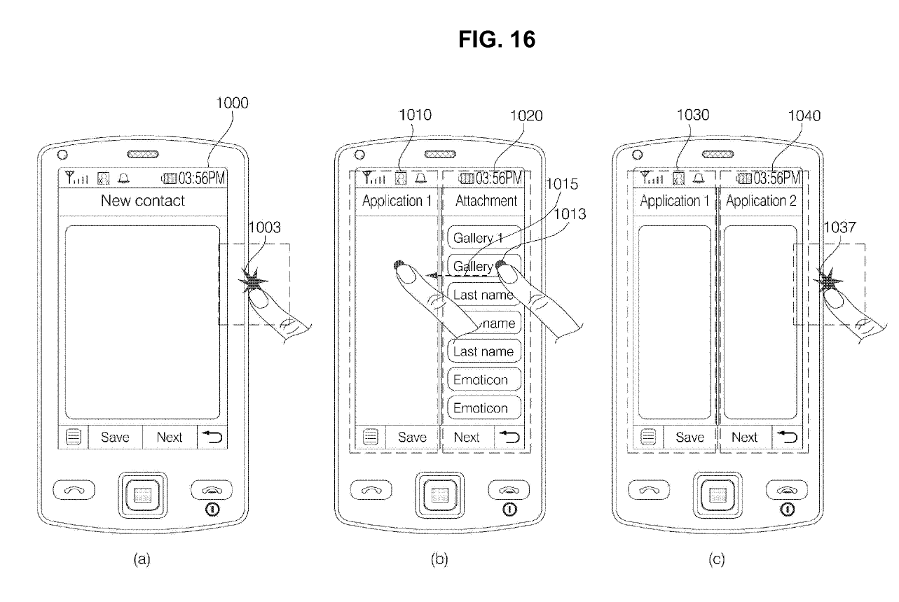

Next, FIG. 16 illustrates the embodiment of FIG. 15, and more particularly, how to perform a multitasking-related control operation. Referring to FIGS. 16(a) and 16(b), in response to a tap input 1003 being detected from the right side of the mobile terminal 100 when a document editor screen 1000 for writing a new email or message is displayed on the display module 151, the display area on the display module 151 can be vertically divided into first and second sections 1010 and 1020, the document editor screen 1000 can be displayed on the first section 1010, and a display screen showing a first set of files that can be attached to or executed in connection with a document being written or edited on the document editor screen 1000 can be displayed on the second section 1020.

In response to a user input 1015 with directivity (such as a right-to-left flick or drag) being detected from one of the files displayed on the second section 1020, the corresponding file can be attached to the document being written or edited on the document editor screen 1000. In response to a left-to-right flick or drag being detected from the second section 1020, a second set of files, which are different from the first set of files, can be displayed on the second section 1020.

Different types of files can be displayed on the second section 1020 for different types of document editor screens. It can be determined in advance what types of files should be displayed in response to a user input being detected from a document editor screen.

In addition, a touch input satisfying a predefined condition (e.g., a touch 1013 touching a particular item for a predetermined amount of time in FIG. 16(b)) results in the execution of the selected file. For example, if the file is a picture, the picture can be displayed in the second section 1020 or displayed on the entire screen.

Further, as shown in FIG. 16(c), the user can perform another tap input 1037 to display two application editor screens 1030 and 1040.

Embodiments Related to Multimedia Player Function

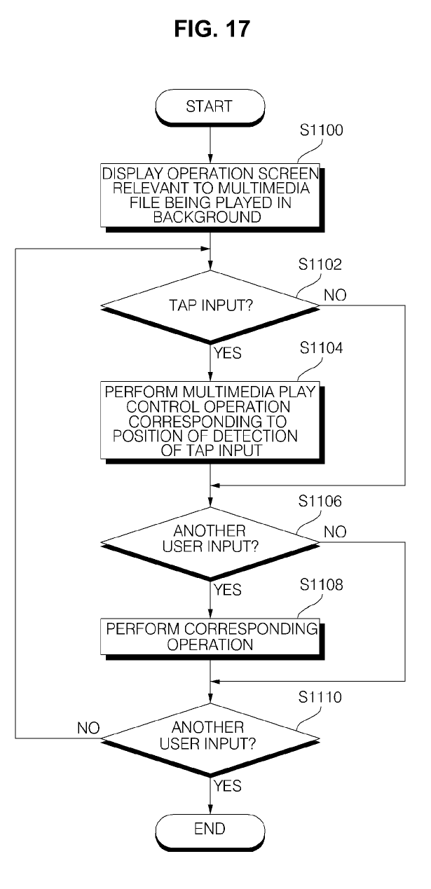

FIG. 17 illustrates a flowchart of an operation control method of a mobile terminal, according to another embodiment of the present invention. Referring to FIG. 17, the controller 180 displays an operation screen relevant to a multimedia player function (such as an MP3 player function) currently being performed in the background on the display module 151 in response to, for example, a user command, being received (S1100).

In response to a tap input being detected from the mobile terminal 100 (Yes in S1102), the controller 180 performs a predefined multimedia play control operation corresponding to a position of the detection of the tap input (S1104). For example, in response to a tap input being detected from the right side of the mobile terminal 100, a subsequent multimedia file to a multimedia file currently being played can be played. In response to a tap input being detected from the left side of the mobile terminal 100, a previous multimedia file to the current multimedia file can be played. In response to a tap input being detected from the upper side of the mobile terminal 100, the volume of the current multimedia file can be increased. In response to a tap input being detected from the lower side of the mobile terminal 100, the volume of the current multimedia file can be reduced.

The user can set in advance the types of multimedia play control operations that can be performed in response to a tap input being detected from the mobile terminal 100. For convenience, in response to a multi-touch input being detected, a guide menu can be additionally provided, indicating the types of multimedia play control operations that can be performed in response to a tap input being detected from the mobile terminal 100. The guide menu can be configured to automatically disappear when the multi-touch input is no longer detected.

In response to a user input, other than a multi-touch input, is detected (Yes in S1106), the controller 180 performs an operation corresponding to the detected user input to be performed (S1108). Operations S1102 through S1108 can be repeatedly performed until the user chooses to end the whole multimedia player function (Yes in S1110).

According to this embodiment, it is possible to effectively control a multimedia player function, which is being performed in the background, in response to a multi-touch input. This embodiment can also be applied to the control of various functions associated with TV or radio broadcast reception, the setting of a Wireless Fidelity (WiFi) or Bluetooth function or the setting of an alarm, and etc.

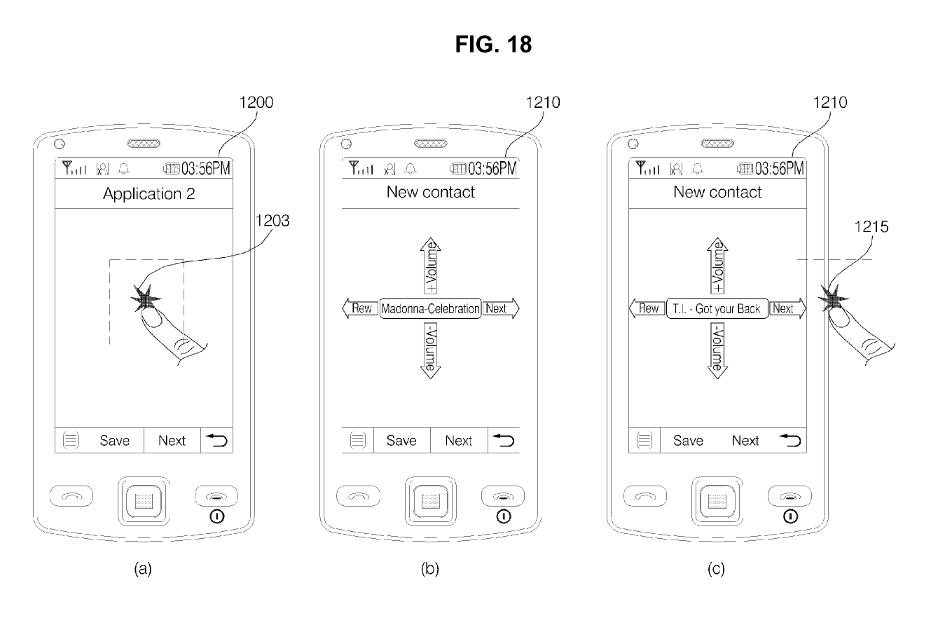

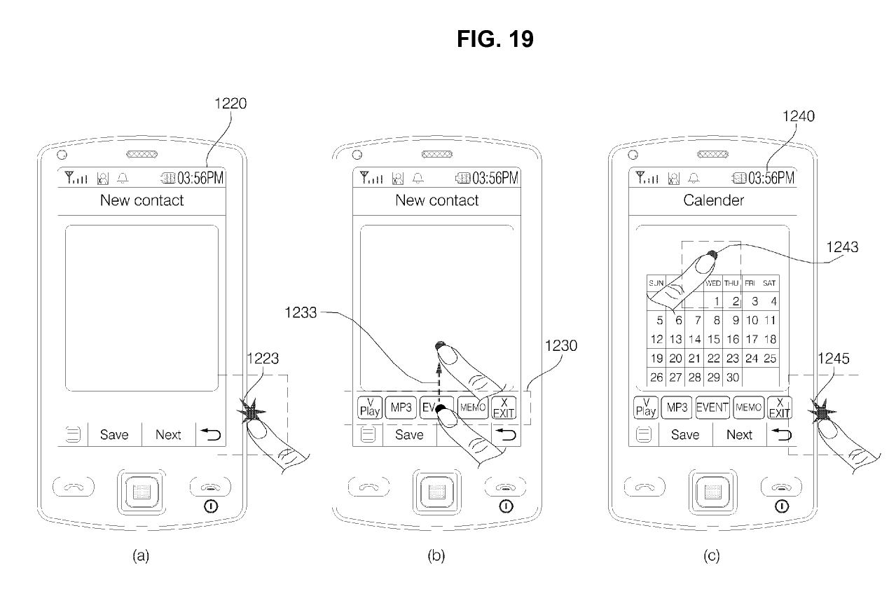

FIGS. 18 and 19 illustrate the embodiment of FIG. 17, and more particularly, how to control a multimedia player function in response to a tap input being detected from the mobile terminal 100. Referring to FIGS. 18(a) and 18(b), in response to a tap input 1203 being detected from an operation screen 1200 relevant to a predetermined music file being played in the background, a display screen 1210 showing a guide menu indicating the types of multimedia play control operations that can be performed by taps on certain parts of the mobile terminal 100 can be displayed. Thus, the user can easily identify where on the mobile terminal 100 to tap to perform a desired multimedia play control operation. The guide menu can be displayed semi-transparently over the operation screen 1210 and can disappear automatically in response to no tap input being detected for more than a predetermined amount of time.

Referring to FIG. 18(c), in response to a tap 1215 on the right side of the mobile terminal 100, information on a subsequent music file to the predetermined music file can be displayed, and the subsequent music file can be played. In short, it is possible to perform various multimedia play control operations on or in connection with a multimedia file being played in the background by using a tap input.

Referring to FIGS. 19(a) and 19(b), in response to a tap input 1223 being detected from an operation screen 1220 relevant to a multimedia file being played in the background, a menu list 1230 including menus that are being executed or can be executed can be displayed over the operation screen 1220. Referring to FIGS. 19(a) and 19(b), in response to a touch-and-drag input 1233 being detected from one item in the menu list 1230, a display screen relevant to the execution of the item selected by the touch-and-drag input 1233 can be displayed. In this manner, it is possible to execute a predetermined menu item in the menu list 1230 by multi-touching the predetermined menu item and an execution item at the same time.

The menu items in the menu list 1230 can be replaced with another group of menu items by a tap input. In response to a touch 1243 on an operation screen 1240 and a tap 1245 on one part of the mobile terminal 100 being detected in a row, a list of items relevant to a function currently being executed can be displayed over the operation screen 1240 (see FIG. 19(c)).

The mobile terminal and the operation control method thereof according to an embodiment of the present invention are not limited to the embodiments set forth herein. Therefore, variations and combinations of the embodiments set forth herein can fall within the scope of the present invention.

The present invention can be realized as code that can be read by a processor included in a mobile terminal and that can be written on a computer-readable recording medium. The computer-readable recording medium can be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

As described above, according to an embodiment of the present invention, it is possible to control various operations performed by a mobile terminal using a tap input and a touch input. In addition, it is possible to facilitate the manipulation of a mobile terminal by using a tap input or a touch input together with a typical key input or a typical touch input.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A method of controlling a mobile terminal, the method comprising:
allowing, via a wireless communication unit of the mobile terminal, wireless communication with at least one other terminal;
displaying, on a touch screen display unit of the mobile terminal, a display screen;
receiving, via a controller of the mobile terminal, a tap input performed on a main body of the mobile terminal; and
dividing, via the controller controlling the touch screen display unit, the display screen into first and second display sections based on the received tap input.

2. The method of claim 1, further comprising:
receiving a touch input on a first item included in a list of items displayed on the display screen;
displaying the list of items in the second display section when the display screen is divided into the first and second display sections; and
displaying a list of data associated with the first item in the first display section in response to the received touch input on the first item.

3. The method of claim 2, wherein the first item comprises a folder, and the data associated with the first item includes at one of data within the folder, data deleted from the folder, and clipboard data associated with the first item.

4. The method of claim 1, further comprising:
receiving a directional touch input on a boarder of one of the first or second display sections; and
increasing and decreasing a size of said one of the first and second display sections based on a movement of the directional touch input.

5. The method of claim 1, wherein when the tap input is on a first side of the main body, the dividing step divides the display screen vertically into the first and second display screens and displays information displayed on the display screen
in the first display section, and when the tap input is on a second side of the main body, the dividing step divides the display screen vertically into the first and second display screens and displays the information displayed on the display screen in the second display section.

6. The method of claim 1, wherein when the tap input is on a top or bottom side of the main body, the dividing step horizontally divides the display screen into the first and second display sections.

7. The method of claim 1, wherein the display screen is a message creation screen, and wherein the dividing step includes displaying the message creating screen in the first display section and displaying files that can be attached to the message creation screen in the second display screen.

8. The method of claim 7, further comprising:
receiving a touch input of one of the files displayed in the second display section and a directional touch input of the touched file into the first display section; and
attaching the touched file to the message creation screen such that when a message created via the message creation screen is transmitted to the at least one other terminal, the attached file is included with the message.

9. The method of claim 8, wherein the file is attached to the message creation screen at a point where the directional touch input is released within the first display section.

10. The method of claim 1, further comprising:
receiving another tap input on the main body of the mobile terminal; and
displaying information displayed in the second display section as a full screen on the touch screen display unit.

11. A mobile terminal, comprising:
a wireless communication unit configured to wirelessly communicate with at least one other terminal;
a touch screen display unit configured to display a display screen; and
a controller configured to receive a tap input performed on a main body of the mobile terminal, and to divide the display screen into first and second display sections based on the received tap input.

12. The mobile terminal of claim 11, wherein the controller is further configured to receive a touch input on a first item included in a list of items displayed on the display screen, and to control the touch screen display unit to display the list of items in the second display section when the display screen is divided into the first and second display sections and to display a list of data associated with the first item in the first display section in response to the received touch input on the first item.

13. The mobile terminal of claim 12, wherein the first item comprises a folder, and the data associated with the first item includes at one of data within the folder, data deleted from the folder, and clipboard data associated with the first item.

14. The mobile terminal of claim 11, wherein the controller is further configured to receive a directional touch input on a boarder of one of the first or second display sections, and to increase and decrease a size of said one of the first and second display sections based on a movement of the directional touch input.

15. The mobile terminal of claim 11, wherein when the tap input is on a first side of the main body, the controller is further divide the display screen vertically into the first and second display screens and to control the display unit to display information displayed on the display screen in the first display section, and
wherein when the tap input is on a second side of the main body, the controller is further configured to divide the display screen vertically into the first and second display screens and to control the display unit to display the information displayed on the display screen in the second display section.

16. The mobile terminal of claim 11, wherein when the tap input is on a top or bottom side of the main body, the controller is further configured to horizontally divide the display screen into the first and second display sections.

17. The mobile terminal of claim 11, wherein the display screen is a message creation screen, and
wherein the controller is further configured to control the display unit to display the message creating screen in the first display section and display files that can be attached to the message creation screen in the second display screen.

18. The mobile terminal of claim 17, wherein the controller is further configured to receive a touch input of one of the files displayed in the first display section and a directional touch input of the touched file into the second display section, and to attach the touched file to the message creation screen such that when a message created via the message creation screen is transmitted to the at least one other terminal, the attached file is included with the message.

19. The mobile terminal of claim 18, wherein the controller is further configured to attach the file to the message creation screen at a point where the directional touch input is released within the first display section.

20. The mobile terminal of claim 11, wherein the controller is further configure to receive another tap input on the main body of the mobile terminal; and to control the display unit to display information displayed in the second display section as a full screen on the touch screen display unit.

21. A method of controlling a mobile terminal, the method comprising:
allowing, via a wireless communication unit of the mobile terminal, wireless communication with at least one other terminal;
capturing, via a camera of the mobile terminal, a camera preview image;
displaying, on a touch screen display unit of the mobile terminal, the camera preview image;
receiving, via a controller of the mobile terminal, a tap input performed on a main body of the mobile terminal; and
displaying, on the touch screen display unit, a panoramic guide for capturing a panoramic image using the camera.

22. The method of claim 21, wherein if the tap input is received on a first side of the main body of the mobile terminal, the panoramic guide is displayed as moving toward the first side of the mobile terminal, and
wherein if the tap input is received on a second side of the main body of the mobile terminal, the panoramic guide is displayed as moving toward the second side of the mobile terminal.

23. The method of claim 21, wherein the camera preview image is displayed on the display unit in response to a touch input being received first on the display unit.

24. A mobile terminal, comprising:
a wireless communication unit configure to wirelessly communicate with at least one other terminal;
a camera configured to capture a camera preview image;
a touch screen display unit configured to display the camera preview image; and
a controller configured to receive a tap input performed on a main body of the mobile terminal, and to control the display unit to display a panoramic guide for capturing a panoramic image using the camera.

25. The mobile terminal of claim 24, wherein if the tap input is received on a first side of the main body of the mobile terminal, the controller is further configured to control the display unit to display the panoramic guide as moving toward the first side of the mobile terminal, and
wherein if the tap input is received on a second side of the main body of the mobile terminal, the controller is further configured to control the display unit to display the panoramic guide as moving toward the second side of the mobile terminal.

26. The mobile terminal of claim 24, wherein the camera preview image is displayed on the display unit in response to a touch input being received first on the display unit.
